(19) United States
(12) Patent Application Publication
(10) Pub. No.: US 2026/0063465 A1
(43) Pub. Date: Mar. 5, 2026

(54) DEVICES, SYSTEMS, AND METHODS FOR MONITORING AND PREDICTING LIQUID PROPANE LEVELS

(71) Applicant: Liquid Insight LLC, Saint Charles, IL (US)

(72) Inventor: Donald M. Blust, Saint Charles, IL (US)

(21) Appl. No.: 19/317,481

(22) Filed: Sep. 3, 2025

Related U.S. Application Data
(60) Provisional application No. 63/689,989, filed on Sep. 3, 2024.

(51) Int. Cl. G01G 19/52; G01G 19/14; G01G 21/28; G01G 23/37

(52) U.S. Cl. CPC G01G 19/52; G01G 19/14; G01G 21/28; G01G 23/3721; G01G 23/3735

(57) ABSTRACT

The present disclosure provides a product demand sensor for weighing an object. The product demand sensor comprises a housing having a first side, a second side, a third side, and a fourth side. The product demand sensor comprises a hook coupled with the fourth side. The product demand sensor comprises a load sensor coupled with the hook, the load sensor being configured to sense a weight of the object supported by the hook. The product demand sensor may be configured to periodically collect weight measurements and support a liquid propane canister for use with a gas grill.

### CROSS-REFERENCE TO RELATED APPLICATIONS

This application claims priority to U.S. Application No. 63/689,989, titled “Devices, Systems, and Methods for Monitoring and Predicting Liquid Propane Levels,” filed Sep. 3, 2024, which is hereby incorporated by reference in its entirety.

### BACKGROUND

Propane-powered grills and outdoor cooking equipment have become increasingly popular for residential and commercial applications. These systems typically utilize refillable propane tanks or canisters that contain liquid propane under pressure. The propane is consumed during cooking operations, requiring periodic replacement or refilling of the containers to maintain continuous operation.

Traditional methods for monitoring propane levels in containers rely on manual inspection techniques or basic mechanical gauges. Weight-based measurement systems have been developed to provide more accurate assessments of remaining propane quantities. These systems incorporate load sensors, electronic processors, and communication interfaces to collect and transmit data regarding container contents. Modern monitoring solutions may include wireless connectivity features that enable remote data access and integration with mobile applications or cloud-based platforms.

### SUMMARY

Some grills operate using refillable propane tanks. Propane tanks are constructed of metal and the user cannot visibly determine the propane level of that container. Propane level is typically determined by weighing the container. Existing weighing mechanisms are of poor quality and accuracy. Oftentimes, the only indication to a user that the propane is running low is an empty container.

To address, among other things, these problems, systems, and methods are provided here for automatically predicting a depreciation in an amount of a contained liquid propane. Using such embodiments, a product demand sensor is engaged with the propane tank. The demand sensor periodically measures the weight of the tank (e.g., every three minutes). In some aspects, this data is transmitted to an analytics engine, where it is refined, consolidated and presented in an easy-to-understand executive dashboard. Using such embodiments, an accurate prediction of a product's usage is provided, allowing a user to preemptively and automatically restock their inventory. In some instances, distributors are able to view customer inventories and predict demands to assist in maintaining their propane tanks.

In some aspects, the techniques described herein relate to a product demand sensor for weighing an object, the product demand sensor including: a housing having a first side, a second side, a third side, and a fourth side; a hook coupled with the fourth side; a load sensor coupled with the hook, the load sensor being configured to sense a weight of the object supported by the hook; and a processor positioned within the housing, the processor configured to communicate with the load sensor.

In some aspects, the techniques described herein relate to a system for remote monitoring and replenishment of propane tanks, the system including: a product demand sensor configured to measure weight of a propane tank and transmit weight measurement data; a facility hub configured to receive the weight measurement data from the product demand sensor and transmit the weight measurement data via a communications network; a server communicatively coupled to the communications network and configured to receive the weight measurement data from the facility hub; an electronic processor configured to analyze the weight measurement data and generate product demand analytics information including propane level predictions and replenishment recommendations; and a portable computing device configured to receive the product demand analytics information and enable automated reordering of propane tanks through the system.

In some aspects, the techniques described herein relate to a product demand monitoring system, the system including: a transceiver; and an electronic processor configured to: receive from a product demand sensor, via the transceiver, a weight measurement corresponding to a weight of a product applied to the product demand sensor; generate, based on the weight measurement and historic weight measurement data corresponding to at least one previously received weight measurement of the product, a liquid level of the product; and display the liquid level on a display unit on the product demand sensor.

Using the embodiments presented herein, users are able to ascertain the real time propane levels and consumption rates of the propane in an easy-to-understand dashboard accessible on any connected device (smartphone, tablet, notebook, or workstation). This provides the user with a definitive view of their propane levels at any given moment. In addition, the demand sensor is configured to be robust, compact, low-cost, and easily attachable to a grill interior using existing attachment points.

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

### BRIEF DESCRIPTION OF THE SEVERAL VIEWS OF THE DRAWINGS

FIG. 1 is a diagram of a product use system in accordance with some embodiments.

FIG. 2 is a schematic diagram of a product demand sensor of the system of FIG. 1 in accordance with some embodiments.

FIG. 3A is a perspective view of a grill surrounding a product demand sensor in accordance with some embodiments.

FIG. 3B is a perspective view of a liquid propane canister supported by the product demand sensor of FIG. 3A in accordance with some embodiments.

FIG. 4A is a front perspective view of the product demand sensor of FIG. 3A in accordance with some embodiments.

FIG. 4B is a side perspective view of the product demand sensor of FIG. 3A in accordance with some embodiments.

FIG. 4C is a rear perspective view of the product demand sensor of FIG. 3A in accordance with some embodiments.

FIG. 5A is a front perspective view of another product demand sensor in accordance with some embodiments.

FIG. 5B is a front perspective view of another product demand sensor in accordance with some embodiments.

FIG. 6 is a front perspective view of another product demand sensor in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Also, it is to be understood that the phraseology and terminology used herein is for the purpose of description and should not be regarded as limiting. The terms “mounted,” “connected,” and “coupled” are used broadly and encompass both direct and indirect mounting, connecting, and coupling. The terms “connected” and “coupled” are not restricted to physical or mechanical connections or couplings, and can include electrical connections or couplings, whether direct or indirect. Electronic communications and notifications described herein may be performed using any known or future-developed means including wired connections, wireless connections, etc.

For ease of description, some or all of the example systems presented herein are illustrated with a single exemplar of each of its component parts. Some examples may not describe or illustrate all components of the systems. Other embodiments may include more or fewer of each of the illustrated components, may combine some components, or may include additional or alternative components.

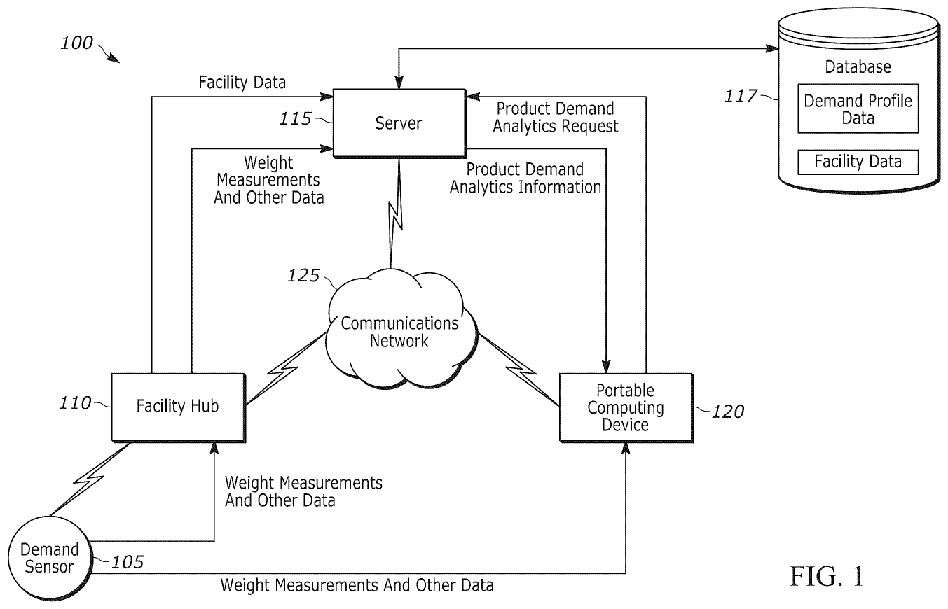

FIG. 1 is a diagram of a predicative product use system 100 in accordance with some embodiments. The system 100 includes a product demand sensor 105, a facility hub 110, and a server 115. The system 100 may also include one or more of a database 117 and a portable computing device 120. The components of the system 100 are communicatively coupled to one another by, for example, a communications network 125. An example communications network 125 includes wireless connections, wired connections, or combinations of both. A suitable communications network may be implemented using various local and wide area networks, for example, a Bluetooth™ network, a Wi-Fi™ network), the Internet, a land mobile radio network, a cellular data network, a Long Term Evolution (LTE) network, a 4G network, a 5G network, or combinations or derivatives thereof.

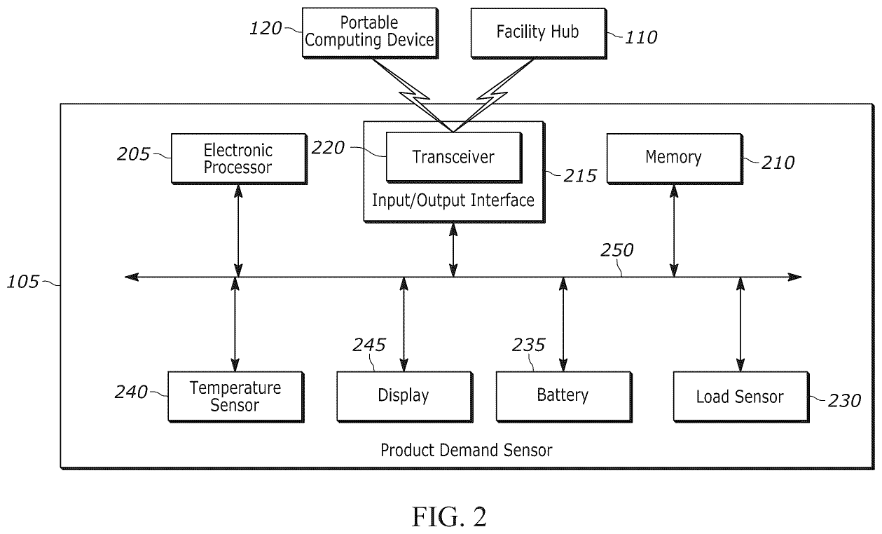

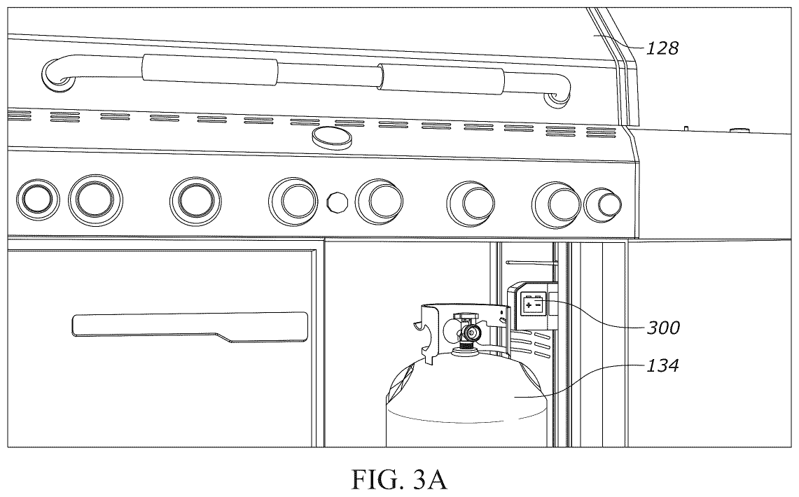

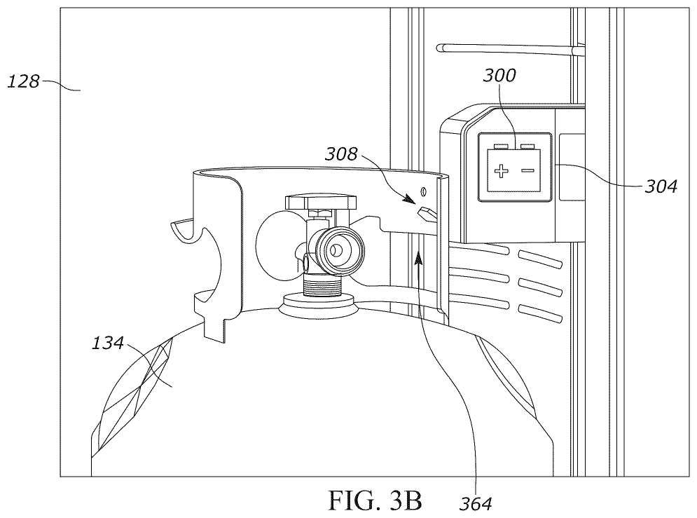

The product demand sensor 105, described in more detail below with respect to FIG. 2, is configured to measure a present weight of a product applied to the product demand sensor 105. As used herein, the term “product” refers to any type of substance, object, or objects (e.g., solid objects, liquids, gasses, gasses stored in pressurized liquid form, and the like) with a measurable weight. Such products, when applied to the product demand sensor 105 for measurement, may be contained in a container (e.g., a vessel for containing liquids or gasses). FIG. 3A illustrates an example of a container for use with the system 100. Specifically, FIG. 3A illustrates a liquid propane canister 134 configured to contain liquid propane for use with a grill 128. As described more particularly herein, in some instances, a product demand sensor is configured to periodically weigh a container disposed on the product demand sensor (e.g., the liquid propane canister 134) as the product within the container is used over time. The weight measurements may then be converted to liquid levels of the liquid propane within the propane canister 134.

Returning to FIG. 1, as described more particularly herein, the product demand sensor 105 periodically collect weight measurement, liquid level measurements, and other data, which are transmitted from the product demand sensor 105 via the facility hub 110 (e.g., an electronic wireless network hub of a facility common to the product demand sensor 105). The facility hub 110 is configured to transmit, via the communications network 125, the weight measurements and other data to the server 115 periodically (e.g., every five minutes). Other data may include, for example, data identifying the facility, the grill model, ambient temperature, measurement time, and the like.

The server 115 is communicatively coupled to, and writes data to and from, the database 117. The database 117 stores data including demand profile data, facility data, and other data according to the methods described herein. As illustrated in FIG. 1, the database 117 is an electronic database housed on a suitable database server communicatively coupled to and accessible by the server 115. In some instances, the server 115, the database 117, or both may be part of a cloud-based database system (for example, a data warehouse) external to the system 100 and accessible by components of the system 100 over one or more wired or wireless networks. In some embodiments, all, or part of the database 117 may be locally stored on the server 115.

As illustrated in FIG. 1, the facility hub 110 may transmit to the server 115 facility data. For example, in a commercial environment (e.g., a restaurant, resort, park, or other facility with one or more devices using propane tanks), the facility data may include location information, customer identity information, and the like. In some embodiments, the facility hub 110 may be operated by or associated with a propane supplier or distributor, enabling automated inventory management and replenishment services.

In some embodiments, the server 115 is configured to analyze the received weight measurement data, the facility data, and other data to produce product demand analytics information. For example, the server 115 may determine from usage trends when a propane tank is likely to run out and produce a demand prediction for the next order or orders for a timeframe in the future (e.g., the next six months). In some instances, the server 115 is configured to provide the product demand analytics information to (automatically or in response to a request from) a portable computing device 120 via the communications network 125. The system 100 may be configured to operate in multiple modes: a local mode where the portable computing device 120 communicates directly with the product demand sensor 105 without transmitting data outside the local facility, and a cloud-based mode where data is transmitted to the server 115 for analysis and automated replenishment services. In the cloud-based mode, the system 100 may enable users to automatically reorder propane tanks through the portable computing device 120, with filled tanks delivered to the user's designated location. In some instances, the portable computing device 120 participates in a local network of the facility housing the product demand sensor 105 and the facility hub 110. In some instances, the portable computing device 120 may be operated remotely from the facility.

Alternatively, or in addition, the product demand sensor 105 may be configured to communicate directly with a mobile application installed on a user's smartphone, tablet, or other portable computing device 120 without requiring connectivity to the facility hub 110, server 115, or cloud-based services. In this local communication variant, the product demand sensor 105 may utilize short-range communication protocols such as Bluetooth Low Energy (BLE), Wi-Fi Direct, Zigbee, Zwave, or other suitable wireless communication methods to establish a direct connection with the portable computing device 120. The transceiver 220 of the product demand sensor 105 may be configured to support these local communication protocols.

In some aspects, this local mode of operation enables the system to function independently without requiring internet connectivity or access to external networks. The mobile application running on the portable computing device 120 may receive weight measurements, liquid level data, and other sensor information directly from the product demand sensor 105. The electronic processor 205 of the product demand sensor 105 may process the load sensor 230 data locally and transmit the processed information to the mobile application. Alternatively, raw sensor data may be transmitted to the portable computing device 120, where the mobile application performs the processing and analysis functions.

The mobile application may provide real-time propane level monitoring, consumption rate calculations, and usage predictions entirely through local processing capabilities of the portable computing device 120. In some cases, the application may store historical usage data locally on the device and generate trend analyses without external data processing. The user interface may display propane levels, estimated remaining usage time, and consumption patterns through an intuitive dashboard accessible on the portable computing device 120. This local communication embodiment may be particularly suitable for residential users who prefer to maintain their usage data privately or for locations where reliable internet connectivity may not be available.

In some aspects, the system 100 includes integration capabilities with existing manufacturer ecosystems and smart home platforms. In some examples, API connectivity enables data sharing with grill control systems, temperature monitoring devices, and cooking management applications. Such integration allows for coordinated cooking and fuel management, with the system providing fuel level information to grill control interfaces and mobile applications.

Other example system configurations support simultaneous monitoring of multiple propane tanks through a single user interface. For example, the system 100 can manage residential setups with multiple grills, commercial installations with several tanks, or mixed-use environments combining residential and commercial applications. The system 100 may provide each monitored tank with individual consumption tracking, maintenance schedules, and replenishment settings while providing consolidated reporting and management through unified dashboard interfaces.

In some aspects, the multi-device capability includes network mesh functionality where individual sensors can communicate with each other to extend wireless range and provide redundant communication paths. In some examples, load balancing algorithms distribute communication traffic across available sensors to optimize battery life and ensure reliable data transmission even in challenging wireless environments.

FIG. 2 schematically illustrates one example of the product demand sensor 105. The illustrated example product demand sensor 105 includes an electronic processor 205, a memory 210, an input/output interface 215 (including a transceiver 220), a load sensor 230, a plurality of batteries 235, a temperature sensor 240, and a display 245. The electronic processor 205 may be implemented as a microprocessor, microcontroller, digital signal processor, or other suitable processing device configured to execute instructions and process data. The memory 210 may include volatile memory (such as RAM) and/or non-volatile memory (such as flash memory, EEPROM, or ROM) for storing program instructions, configuration data, and measurement data. The input/output interface 215 provides connectivity between the internal components and external devices, and includes a transceiver 220 that may support various communication protocols such as Bluetooth, Wi-Fi, cellular (LTE, 4G, 5G), or other wireless communication standards. The load sensor 230 may be implemented as a strain gauge, load cell, force sensor, or other weight measurement device capable of detecting changes in applied force or weight. The plurality of batteries 235 may include rechargeable or non-rechargeable batteries such as lithium-ion, alkaline, or other battery types configured to provide power to the sensor components. The temperature sensor 240 may be a thermistor, thermocouple, or other temperature measurement device for monitoring ambient or component temperatures. In some embodiments, the product demand sensor 105 features a display 245, which provides a user-friendly interface for viewing real-time weight measurements, liquid levels, or status indicators directly on the device. The display 245 may utilize LCD or OLED technology to ensure clear visibility, and is typically positioned on the housing for convenient access during operation. The illustrated components, along with other various modules and components are coupled to each other by or through one or more control and/or data buses (e.g., the bus 250) that enable communication therebetween. The use of control and data buses for the interconnection between and exchange of information among the various modules and components would be apparent to a person skilled in the art in view of the description provided herein. In some embodiments, the product demand sensor 105 includes fewer or additional components in configurations different from the example illustrated in FIG. 2. For example, in some embodiments, the product demand sensor 105 lacks a temperature sensor. The product demand sensor 105 may include various digital and analog components, which for brevity are not described herein and which may be implemented in hardware, software, or a combination of both.

The components of the product demand sensor 105 are contained in a housing. The housing and its configuration are not illustrated in FIG. 2. Specific example embodiments of the product demand sensor 105 are illustrated in FIGS. 3A-6 and described in more detail below.

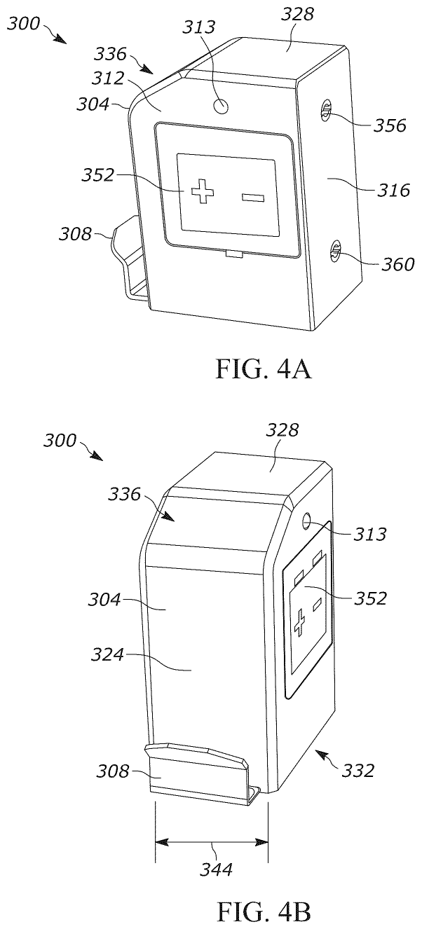

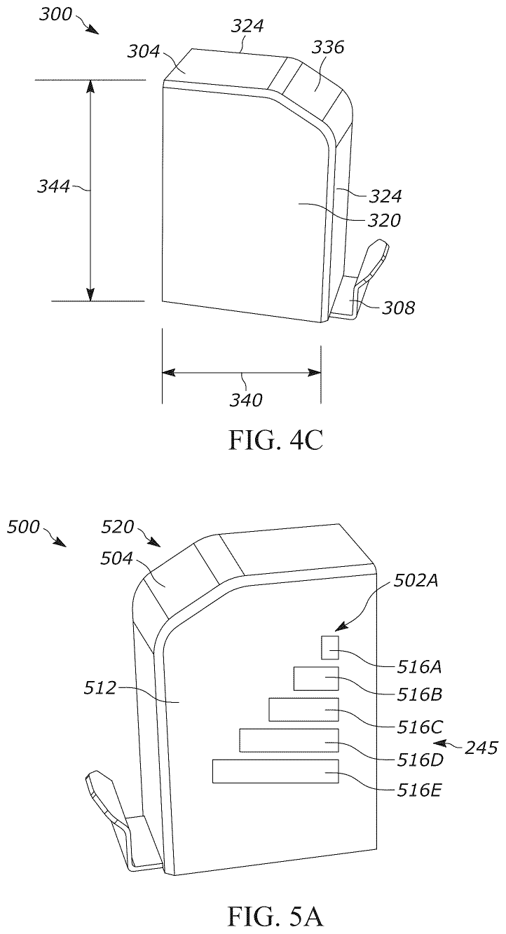

FIGS. 3A-4C illustrate an example embodiment 300 of the product demand sensor 105 for measuring and tracking the weight of a liquid container. In some embodiments, the liquid container is a liquid propane canister 134. In some examples and applications, the liquid container may hold other liquids. In the illustrated embodiment, the product demand sensor 300 is configured to support a liquid propane canister 134 for use with a gas grill 128. The product demand sensor 300 may be configured to support a variety of liquid propane canister 134 sizes.

The product demand sensor 105 includes a housing 304 substantially rectangular in shape and a hook 308 for supporting and receiving the liquid propane tank 134. The housing 304 is rigid and has a compact form factor. In the present embodiment, the housing 304 is made of glass filled nylon which gives the housing 304 a high strength and improved heat resistance. For example, the housing 304 has a melting point well above 300 degrees Fahrenheit. Accordingly, the housing 304 protects the sensor 105 such that the sensor 105 is operable between 14 degrees Fahrenheit and 104 degrees Fahrenheit.

The housing 304 includes a first side 312, a second side 316, a third side 320, a fourth side 324, a top 328, and a bottom 332. A chamfer 336 is positioned between the top 328 and the fourth side 324. The housing 304 has a length 340 measured between the second side 316 and the fourth side 324, a width 344 measured between the first side 312 and the third side 320, and a height 348 measured between the top 328 and the bottom 332. In the present embodiment, the housing 304 has a length 340 of approximately 3 inches, or 7.6 centimeters, the housing 304 has a width 344 of approximately 2 inches, or 5 centimeters, and the housing 304 has a height 348 of approximately 4 inches, or 10.2 centimeters.

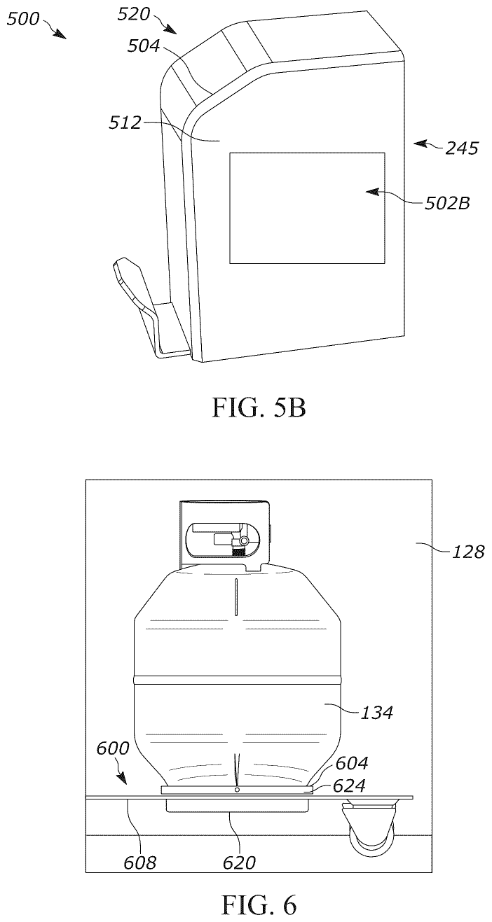

The first side 312 includes a battery receptacle 352 for receiving batteries to power the product demand sensor 105. The first side 312 further includes a light emitting diode (LED) 313 configured to show the charge status of the batteries within the battery receptacle 352. In the present embodiment, the battery receptacle 352 is configured to receive three AA batteries. However, in other embodiments, the battery receptacle 352 may receive a different type or quantity of batteries. For example, when the batteries are fully charged, the LED is green. When the batteries are low on charge, the LED is red. It should be understood that other LED colors may be used to signal the charge status of the batteries. The second side 316 includes a first aperture 356 and a second aperture 360 each configured for receiving a threaded fastener (not shown) such as a screw. In other embodiments, the apertures 356/360 may be configured to receive any of a plurality of different fasteners (e.g., screws, bolts, nails, rivets, etc.). The first aperture 356 and the second aperture 360 are configured to allow the product demand sensor 105 to be attached to the inside of the grill 128 via the fasteners. In some embodiments, the third side 320 may include a display 245 for showing the weight or liquid levels of the liquid propane tank (FIGS. 5A, 5B).

The fourth side 324 includes a hook 308 receivable through a canister aperture 364 positioned on a top of the liquid propane canister 134. In the present embodiment, the hook 308 is metal and is configured to allow the product demand sensor to hang from a suitable mount point the grill 128 and support the entire weight of the liquid propane canister 134 (whether empty or full). In some specifications, the hook 308 is configured to support a maximum weight of over 100 pounds. In one embodiment, the hook 308 is made of aluminum to provide robust support and prevent rusting and degradation over time. In alternate embodiments, the hook 308 may be any of a plurality of different materials (e.g., steel, composite, carbon fiber, plastic, glass, polymer, etc.) or combinations thereof.

The product demand sensor 105 further includes the load sensor 230 coupled with the hook 308 for sensing the force tension on the hook 308 caused by the weight of the liquid propane canister 134. In one embodiment, the load sensor 230 is a 4× half bridge load sensor array. In other embodiments, the product demand sensor 105 may instead include a micro-load half bridge sensor, a sheer beam sensor, or any suitable sensor or combination of sensors.

In some embodiments, the product demand sensor 105 is configured to automatically detect and adapts to different propane tank capacities, including standard 20-pound residential tanks, 30-pound and 40-pound extended capacity tanks, and commercial-grade tanks of larger capacities. Automatic tank recognition algorithms analyze consumption patterns and sensor readings to determine tank capacity and adjust level calculations accordingly. In some embodiments, the product demand sensor 105 stores or accesses compatibility databases for various tank manufacturers and models to ensure accurate monitoring across different tank specifications.

FIGS. 5A-5B illustrate another example embodiment 500 of the product demand sensor 105. The product demand sensor 500 includes a display (e.g., an embodiment of the display 245) positioned on a housing 504 similar to the housing 304 of the product demand sensor 300. Unlike the product demand sensor 105, the product demand sensor 500 includes a battery receptacle 352 on a third side 520 of the housing 504 rather than a first side 512 of the housing 504. Instead, the first side 512 of the housing 504 includes the display 502 on the first side 512 of the housing 504.

The display 245 may be any of a plurality of suitable displays, such as a liquid crystal display (LCD) screen, an organic light-emitting diode (OLED) screen, and the like. In some embodiments, the processor 205 may display the measured/computed weight and/or liquid levels on the display 245.

In the embodiment shown in FIG. 5A, the display 245 is an LED bar graph 502A configured to display the quantity of liquid propane in the liquid propane canister 134. The LED bar graph 502A includes a plurality of bars 516A-E which are configured to light up according to the liquid levels of the liquid propane. For example, the bars 516A-E may comprise LEDs of varying colors, intensities, and blinking patterns to convey different operational states and alert conditions. Color coding schemes may indicate normal operation (green), low levels (yellow/amber), critical levels (red), system errors (flashing red), or maintenance requirements (blue). The intensity and blinking frequency of indicators 516A-E may be user-configurable to accommodate different ambient lighting conditions and personal preferences. For example, when the propane canister 134 is fully filled, all five of the bars 516A-E are illuminated. In contrast, when the propane canister 134 is empty, only the smallest bar 516A is illuminated. When the propane canister 134 is only partially filled, only three bars 516A-C are illuminated. In other examples, the display includes a plurality of visual indicators, which may be arranged in various geometric patterns including linear arrays, circular arrangements, arc configurations, matrix displays, or other suitable configurations optimized for visibility and user comprehension

The position and arrangement of any visual indicators may be configured based on tank geometry, mounting orientation, and user visibility requirements. In certain embodiments, the indicator arrangement adapts to different tank sizes and shapes, with the control system automatically adjusting the display mapping to provide accurate level representation regardless of tank configuration.

In the embodiment shown in FIG. 5B, the display 245 is an LCD or OLED screen 502B which displays data such as the weight of the propane canister 134 and the liquid level of the propane canister 134. In the present embodiment, the screen 502B displays the aforementioned data in the form of text. In alternate embodiments, the screen 502B may display the data in the form of a digital bar graph, an image, or any other suitable method of display.

In some aspects, the screen 502B may display additional information beyond weight and liquid level measurements. The display may show consumption rate data, indicating how quickly the propane is being used over time, which may be calculated based on historical weight measurements stored in the memory 210. The screen 502B may also present estimated remaining usage time, providing users with predictive information about when the propane canister 134 may need replacement based on current consumption patterns.

The display 502B may be configured to show multiple data views that users can cycle through using input controls (not shown) on the housing 504. In some cases, the display may present a real-time monitoring view showing current weight and liquid level, a historical usage view displaying consumption trends over selectable time periods (such as daily, weekly, or monthly), and a settings view allowing users to configure display preferences, measurement units, and alert thresholds.

In some embodiments, the screen 502B may incorporate graphical elements such as trend lines, bar charts, or gauge-style indicators to present data in an intuitive visual format. The display may use different background colors or visual indicators to communicate system status, such as normal operation, low battery warnings, connectivity issues, or sensor calibration requirements.

The product demand sensor 500 may include user interface elements such as buttons, touch-sensitive areas, or proximity sensors that allow users to interact with the display 502B. In some cases, the display may automatically adjust its brightness based on ambient light conditions detected by an optional light sensor, or may include a backlight that can be activated manually or automatically when the sensor detects user proximity.

The housing 504 may be designed with similar materials and construction as the housing 304, providing durability and weather resistance suitable for outdoor grill environments. In some aspects, the housing 504 may include additional sealing around the display 502B to protect the electronic components from moisture, dust, and temperature variations commonly encountered in outdoor cooking environments.

FIG. 6 illustrates another example embodiment 600 of the product demand sensor 105. The product demand sensor 600 includes a platform 604 positioned in a frame 608 of the grill 128. The frame 608 includes a circular floor cutout positioned within the grill 128. Unlike the product demand sensor 105, the product demand sensor 600 does not include a hook and has a circular shape. Rather, the product demand sensor 600 is configured to support a base of the liquid propane canister 134.

As illustrated, the platform 604 includes a substantially planar bottom surface 620 and a flange 624 which extends circumferentially from the bottom surface 620. The flange 624 has a frustoconical shape and extends axially upward and radially outward from the bottom surface 620 such that an outer circumference of the flange has a radius that is greater than a radius of the bottom surface 620. The frustoconical shape of the flange 624 provides a tapered profile that gradually increases in diameter from an inner edge adjacent to the bottom surface 620 to the outer circumference. This configuration creates a smooth transition that facilitates proper seating of the propane canister 134 while providing structural support. Accordingly, the bottom surface 620 and the flange 624 create a cupped shape that forms a receptacle specifically designed to accommodate the base geometry of standard propane canisters. The bottom surface 620 has a smaller radius than a radius of the circular floor cutout positioned within the grill frame 608. In contrast, the outer circumference of the flange 624 has a radius that is larger than the radius of the circular floor cutout. This dimensional relationship ensures proper positioning and support of the platform 604 within the grill structure. Accordingly, when the platform 604 is positioned in the frame 608, the bottom surface 620 extends through the circular floor cutout such that the outer circumference of the flange 624 rests on the frame 608 of the grill 128. The flange 624 acts as a support rim that distributes the weight of the platform 604 and the supported propane canister 134 across the frame 608. In other words, the platform 604 floats in the frame 608 such that the flange 624 supports the platform within the frame 608 of the grill 128, creating a suspended mounting configuration that isolates the load sensor from external forces and vibrations that might otherwise affect measurement accuracy. Accordingly, the cupped shape of the platform 604 is configured to receive and support a base of the liquid propane canister 134 such that the flange 624 surrounds the base and resists relative movement of the canister. The flange 624 provides lateral constraint that prevents the propane canister 134 from shifting or tilting during use, which could otherwise introduce measurement errors or create safety concerns. The platform 604, therefore, stabilizes the liquid propane canister 134, allowing for more accurate measurement of the weight of the liquid canister 134 by maintaining consistent positioning and minimizing external influences on the load sensor readings. The product demand sensor 600 further includes the load sensor 230 coupled to the bottom surface 620 for sensing the force tension caused by the weight of the liquid propane canister 134. The load sensor 230 may be positioned centrally within the bottom surface 620 to optimize weight distribution and measurement accuracy. The platform 604 further includes a circuit housing (not shown) within the bottom surface 620. The circuit housing is configured to protect electronic components from environmental conditions while maintaining accessibility for maintenance and battery replacement. The circuit housing receives a lithium-ion battery and a printed circuit board that contains the electronic processor, memory, and communication components necessary for sensor operation. The lithium-ion battery provides extended operational life and reliable power delivery in outdoor environments. A circuit cover may be removably coupled to the circuit housing to provide weatherproof protection while allowing access to internal components when necessary. The circuit cover may include sealing elements such as gaskets or O-rings to prevent moisture ingress and maintain the integrity of the electronic components.

In some embodiments, the product demand sensor 105 may further include an overmolded gasket and a conformal coated PCBA.

In the foregoing specification, specific embodiments are described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

It should also be noted that a plurality of hardware and software-based devices, as well as a plurality of different structural components may be utilized to implement the embodiments provided herein. It should also be noted that a plurality of hardware and software-based devices, as well as a plurality of different structural components may be used to implement the invention. In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processors. As such, it should be noted that a plurality of hardware and software-based devices, as well as a plurality of different structural components may be utilized to implement the invention. For example, “control units” and “controllers” described in the specification can include one or more processors, one or more application specific integrated circuits (ASICs), one or more memory modules including non-transitory computer-readable media, one or more input/output interfaces, and various connections (e.g., a system bus) connecting the components.

It will be appreciated that some embodiments may be comprised of one or more electronic processors such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, some embodiments may be implemented as a computer-readable storage medium having computer readable code stored thereon for programming a computer (e.g., comprising an electronic processor) to perform a method as described and claimed herein. Examples of such computer-readable storage media include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

It should be understood that although certain drawings illustrate hardware and software located within particular devices, these depictions are for illustrative purposes only. In some examples, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among multiple different devices.

In this specification, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way but may also be configured in ways that are not listed.

The following paragraphs provide various examples and alternatives disclosed herein.

Example 1. A product demand sensor for weighing an object, the product demand sensor comprising: a housing having a first side, a second side, a third side, and a fourth side; a hook coupled with the fourth side; and a load sensor coupled with the hook, the load sensor being configured to sense a weight of the object supported by the hook, wherein the first side includes a battery receptacle configured to receive one or more batteries to power the product demand sensor.

Example 2. The product demand sensor of example 1, wherein the product demand sensor is configured to periodically collect weight measurements.

Example 3. The product demand sensor of example 1, wherein the hook is configured to support a liquid propane canister for use with a gas grill.

Example 4. The product demand sensor of example 1, wherein the load sensor is a half bridge load sensor array.

Example 5. The product demand sensor of example 1, wherein the housing is made of glass filled nylon.

Example 6. The product demand sensor of example 1, wherein the housing has a melting point of above 300 degrees Fahrenheit.

Example 7. The product demand sensor of example 1, wherein the load sensor is operable between 14 degrees Fahrenheit and 104 degrees Fahrenheit.

Example 8. The product demand sensor of example 1, wherein the hook is made of one or more selected from a group consisting of aluminum, steel, carbon fiber, composite, and plastic.

Example 9. The product demand sensor of example 1, wherein the housing has a length of about 3 inches, a width of about 2 inches, and a height of about 4 inches.

Example 10. The product demand sensor of example 1, wherein the product demand sensor is waterproof.

Example 11. The product demand sensor of example 1, wherein the first side of the housing includes a light emitting diode configured to show a charge state of the one or more batteries.

Example 12. The product demand sensor of example 1, wherein the second side includes a plurality of apertures configured for receiving threaded fasteners.

Example 13. The product demand sensor of example 1, further comprising a display for showing a weight of the object.

Example 14. A product demand sensor for weighing an object, the product demand sensor comprising: a housing having a first side, a second side, a third side, and a fourth side; a hook coupled with the fourth side; a load sensor coupled with the hook, the load sensor being configured to sense a weight of the object supported by the hook; and a processor positioned within the housing, the processor configured to communicate with the load sensor, wherein the first side includes a display for showing a weight of the object.

Example 15. The product demand sensor of example 14, wherein the display is an LED bar graph.

Example 16. The product demand sensor of example 14, wherein the display is one selected from the group consisting of an LCD screen or an OLED screen.

Example 17. The product demand sensor of example 14, wherein the product demand sensor is configured to periodically collect weight measurements.

Example 18. The product demand sensor of example 14, wherein the hook is configured to support a liquid propane canister for use with a gas grill.

Example 19. The product demand sensor of example 18, wherein the processor is configured to display a measured weight and/or a computed liquid level of the propane canister on the display.

Example 20. A product demand sensor for weighing an object, the product demand sensor comprising: a platform having: a substantially planar bottom surface configured to support the object, a flange having a frustoconical shape and extending from the bottom surface such that an outer circumference of the flange has a radius that is greater than a radius of the bottom surface, and a load sensor positioned in the platform and configured to sense a weight of the object, wherein the platform is configured to receive and support the object thereby transmitting the weight of the object to the load sensor.

Example 21. The product demand sensor of example 20, wherein the substantially planar bottom surface and the flange create a cupped shape.

Example 22. The product demand sensor of example 20, the platform further includes a circuit housing within the substantially planar bottom surface.

Example 23. The product demand sensor of example 22, wherein the circuit housing receives a lithium-ion battery and a printed circuit board.

Example 24. The product demand sensor of example 20, wherein the flange is annular and has a constant thickness.

Example 25. A product demand monitoring system, the system comprising: a transceiver; and an electronic processor configured to: receive from a product demand sensor, via the transceiver, a weight measurement corresponding to a weight of a product applied to the product demand sensor; generate, based on the weight measurement and historic weight measurement data corresponding to at least one previously received weight measurement of the product, a liquid level of the product; and display the liquid level on a display unit on the product demand sensor.

Example 26. A system for remote monitoring and replenishment of propane tanks, the system comprising: a product demand sensor configured to measure weight of a propane tank and transmit weight measurement data; a facility hub configured to receive the weight measurement data from the product demand sensor and transmit the weight measurement data via a communications network; a server communicatively coupled to the communications network and configured to receive the weight measurement data from the facility hub; an electronic processor configured to analyze the weight measurement data and generate product demand analytics information including propane level predictions and replenishment recommendations; and a portable computing device configured to receive the product demand analytics information and enable automated reordering of propane tanks through the system.

Example 27. The system of example 26, wherein the system is configured to operate in a local mode where the portable computing device communicates directly with the product demand sensor without transmitting data to the server, and a cloud-based mode where the weight measurement data is transmitted to the server for analysis.

Example 28. The system of example 26, wherein the electronic processor is configured to: receive facility data from the facility hub identifying a location and customer information; analyze consumption trends from the weight measurement data to determine when the propane tank is likely to run out; and generate demand predictions for future propane orders based on the consumption trends.

Example 29. The system of example 28, wherein the electronic processor is configured to automatically generate replenishment orders when propane levels fall below predetermined thresholds and coordinate delivery of filled propane tanks to a user-designated location.

Example 30. The system of example 26, wherein the product demand sensor comprises a transceiver configured to communicate with the facility hub using one or more communication protocols selected from the group consisting of Bluetooth, Wi-Fi, cellular, Zigbee, and Zwave.

Example 31. The system of example 26, further comprising a database communicatively coupled to the server and configured to store demand profile data, facility data, and historical weight measurement data for generating the product demand analytics information.

Various features and advantages of the embodiments presented herein are set forth in the following claims.

What is claimed is:

1. A product demand sensor for weighing an object, the product demand sensor comprising:
a housing having a first side, a second side, a third side, and a fourth side;
a hook coupled with the fourth side;
a load sensor coupled with the hook, the load sensor being configured to sense a weight of the object supported by the hook; and
a processor positioned within the housing, the processor configured to communicate with the load sensor.

2. The product demand sensor of claim 1, wherein the product demand sensor is configured to periodically collect weight measurements.

3. The product demand sensor of claim 1, wherein the hook is configured to support a liquid propane canister for use with a gas grill.

4. The product demand sensor of claim 1, wherein the load sensor is a half bridge load sensor array.

5. The product demand sensor of claim 1, wherein the housing is made of glass filled nylon.

6. The product demand sensor of claim 1, wherein the housing has a melting point of above 300 degrees Fahrenheit.

7. The product demand sensor of claim 1, wherein the load sensor is operable between 14 degrees Fahrenheit and 104 degrees Fahrenheit.

8. The product demand sensor of claim 1, wherein the hook is made of one or more selected from a group consisting of aluminum, steel, carbon fiber, composite, and plastic.

9. The product demand sensor of claim 1, wherein the product demand sensor is waterproof.

10. The product demand sensor of claim 1, wherein the first side includes a battery receptacle configured to receive one or more batteries to power the product demand sensor.

11. The product demand sensor of claim 10, wherein the first side of the housing includes a light emitting diode configured to show a charge state of the one or more batteries.

12. The product demand sensor of claim 1, wherein the second side includes a plurality of apertures configured for receiving threaded fasteners.

13. The product demand sensor of claim 1, further comprising a display, wherein the processor is configured to display a measured weight and/or a computed liquid level for the object on the display.

14. The product demand sensor of claim 13, wherein the display is an LED bar graph.

15. The product demand sensor of claim 13, wherein the display is one selected from the group consisting of an LCD screen or an OLED screen.

16. A system for remote monitoring and replenishment of propane tanks, the system comprising:
a product demand sensor configured to measure weight of a propane tank and transmit weight measurement data;
a facility hub configured to receive the weight measurement data from the product demand sensor and transmit the weight measurement data via a communications network;
a server communicatively coupled to the communications network and configured to receive the weight measurement data from the facility hub;
an electronic processor configured to analyze the weight measurement data and generate product demand analytics information including propane level predictions and replenishment recommendations; and
a portable computing device configured to receive the product demand analytics information and enable automated reordering of propane tanks through the system.

17. The system of claim 16, wherein the system is configured to operate in a local mode where the portable computing device communicates directly with the product demand sensor without transmitting data to the server, and a cloud-based mode where the weight measurement data is transmitted to the server for analysis.

18. The system of claim 16, wherein the electronic processor is configured to:
receive facility data from the facility hub identifying a location and customer information;
analyze consumption trends from the weight measurement data to determine when the propane tank is likely to run out; and
generate demand predictions for future propane orders based on the consumption trends.

19. The system of claim 18, wherein the electronic processor is configured to automatically generate replenishment orders when propane levels fall below predetermined thresholds and coordinate delivery of filled propane tanks to a user-designated location.

20. A product demand monitoring system, the system comprising:
a transceiver; and
an electronic processor configured to:
receive from a product demand sensor, via the transceiver, a weight measurement corresponding to a weight of a product applied to the product demand sensor;
generate, based on the weight measurement and historic weight measurement data corresponding to at least one previously received weight measurement of the product, a liquid level of the product; and
display the liquid level on a display unit on the product demand sensor.
